(19) United States
(12) Patent Application Publication
(10) Pub. No.: US 2018/0070775 A1
(43) Pub. Date: Mar. 15, 2018

(54) PREPARATION VESSEL FOR AN ELECTRIC MOTOR-OPERATED FOOD PROCESSOR

(71) Applicant: Vorwerk & Co. lnterholding GmbH, Wuppertal (DE)

(72) Inventor: Markus CORNELlSSEN, Bornheim (DE)

(73) Assignee: Vorwerk & Co. lnterholding GmbH, Wuppertal (DE)

(21) Appl. No.: 15/698,891

(22) Filed: Sep. 8, 2017

(30) Foreign Application Priority Data
Sep. 9, 2016 (DE) 10 2016 116 975.7

(51) Int. Cl. A47J 43/07; B02C 18/12; B02C 18/16; B01F 15/00; B01F 15/06

(52) U.S. Cl. CPC A47J 43/0761; B02C 18/12; B02C 18/16; B01F 2015/062; B01F 15/066; B01F 2215/0014; B01F 15/00538

(57) ABSTRACT

A preparation vessel with a vessel floor, a heating device and a foot part that can be externally connected with the vessel floor, wherein the preparation vessel can be connected by way of the foot part with a base unit of an electric motor-operated food processor. In order to be able to use the preparation vessel even at high temperatures, it is proposed that a heat protection element with a temperature resistance of at least 160° C., in particular of at least 200° C., be arranged between the vessel floor and foot part, in particular between the heating device and foot part.

### AREA OF TECHNOLOGY

The invention relates to a preparation vessel with a vessel floor, a heating device and a foot part that can be externally connected with the vessel floor, wherein the preparation vessel can be connected by way of the foot part with a base unit of an electric motor-operated food processor.

In addition, the invention relates to an electric motor-operated food processor with a base unit and a preparation vessel that can be connected with the base unit, wherein the preparation vessel has a vessel floor, a heating device and a foot part that can be externally connected with the vessel floor.

### PRIOR ART

Preparation vessels and electric motor-operated food processors of the aforementioned kind are known in prior art.

For example, publication WO 2003/001952 A2 discloses an electric motor-operated food processor along with a preparation vessel, in which the vessel floor has a heating device in the form of an electrical resistance heater, which is integrated into the vessel floor. Contact elements that protrude over the vessel floor are provided for electrically contacting the resistance heater, and can be connected with a power supply when the preparation vessel is in a position inserted into the base unit.

Additionally known from EP 2 875 762131, for example, is to arrange a foot part on the vessel floor that simultaneously fixes an agitator extending through the vessel floor of the preparation vessel. The foot part is used to fasten the agitator to the preparation vessel on the one hand, and to shield the hot vessel floor against inadvertent contact with sensitive surfaces or a user of the food processor on the other.

Since the foot part usually consists of a plastic part, heating the vessel floor is limited to a temperature that does not lead to a material change.

### SUMMARY OF THE INVENTION

Proceeding from the aforementioned prior art, the object of the invention is to indicate a preparation vessel or an electric motor-operated food processor with such a preparation vessel, in which the preparation vessel can be heated by means of the heating device as independently of the foot part material as possible.

Initially proposed for achieving the aforementioned object is a preparation vessel, in which a heat protection element with a temperature resistance of at least 160° C., in particular of at least 200° C., is arranged between the vessel floor and foot part, in particular between the heating device and foot part.

According to the invention, the preparation vessel is now configured in such a way that the heating process cannot impair the foot part, e.g., melt the foot part. The preparation vessel now has a heat protection element between the vessel floor and foot part that keeps the heat radiated by the heating device away from the foot part. The preparation vessel together with the foot part can be manufactured unchanged, for example as described in prior art. The difference is now that a heat protection element is present as a thermal insulator at all locations where the foot part abuts directly against the vessel floor of the preparation vessel. In particular, the heat protection element is arranged between the heating device and foot part. The heating device can here basically be integrated into the vessel floor, or be arranged on the vessel floor from outside. In the first instance, for example, it is recommended that the heating device be a thick-film heater, or some other resistance heater. The heat protection element has a temperature resistance of at least 160° C., in particular of at least 200° C. This temperature resistance is sufficient for heating media at a temperature of 160° C. inside of the preparation vessel without negatively influencing the material of the foot part. Since temperatures exceeding 160° C. can potentially be reached between the heating device and foot part, it may be desirable for the heat protection element to have a temperature resistance higher than that, e.g., the proposed temperature resistance of at least 200° C.

It is proposed that the heat protection element be a silicone layer, in particular a fluorinated silicone layer. Therefore, silicone is proposed as a thermal insulator, since it has the desired temperature resistance. Depending on the type of used silicone, a temperature resistance of up to 250° C. or even up to 350° C. can be achieved. In addition, silicones can be manufactured in such a way as to satisfy the requirements placed on foods with respect to safety and fitness for purpose. The silicone layer preferably has a thickness of only a few millimeters, preferably a thickness of up to only one millimeter, so that the silicone layer is especially flexible, and can be embedded into the geometry of the preparation vessel, including the foot part, without any structural changes being needed. Due to its flexibility, the silicone layer adjusts to the geometry of the preparation vessel or vessel floor and/or foot part, so that it can be integrated especially advantageously. The silicone layer is also advantageously fluorinated, so as to provide a better sliding capacity relative to the vessel floor of the preparation vessel, which is usually made out of metal. Silicone usually slides relatively poorly on metal. This disadvantage is overcome through fluorination. This facilitates the arrangement of the heat protection element on the preparation vessel, in particular the relative displacement of the heat protection element to the vessel floor and/or potentially also a circumferential wall of the preparation vessel.

In addition, it is proposed that the heat protection element be detachably arranged on the preparation vessel and/or foot part. This embodiment allows a user to optionally detach the heat protection element from the preparation vessel or attach it thereto. In particular, the heat protection element can be removed especially easily for purposes of replacing or for purposes of cleaning the preparation vessel and/or foot part. On the other hand, it is of course alternatively also possible that the heat protection element not be detachable from the preparation vessel or foot part without it being destroyed. In this embodiment, the preparation vessel and heat protection element or the foot part and heat protection element comprise a unit. This embodiment requires no adjustment of the heat protection element when detaching the foot part from the preparation vessel and then once again attaching it thereto. For example, the heat protection element can especially advantageously be molded onto the foot part or the like. The user here detaches the foot part together with the heat protection element from the preparation vessel, for example prior to cleaning in a dishwasher.

In addition, it is proposed that the heat protection element cover at least one partial area of the vessel floor, in particular at least one partial area that would be in direct mechanical contact with the foot part in the absence of the heat protection element. The heat protection element thus covers those outwardly facing partial areas of the vessel floor against which the foot part directly abuts, and is hence exposed to an especially high temperature. As a consequence, the partial areas of the vessel floor to be covered are on the one hand determined by the geometry of the vessel floor itself, but on the other hand also by the geometry of the foot part. If the vessel floor or foot part does not involve a flat surface, then in particular those partial areas are to be covered that protrude in the direction of the respective other element, i.e., either in the direction of the vessel floor or in the direction of the foot part.

Furthermore, it is proposed that the heat protection element cover at least a partial area of a circumferential wall of the preparation vessel. According to this embodiment, the heat protection element abuts not only against the vessel floor of the preparation vessel, but rather also against its circumferential wall. As a consequence, the heat protection element can especially advantageously be guided simultaneously over the vessel floor and circumferential wall, wherein a flexibility for the heat protection element is recommended in particular, e.g., in the form of a silicone layer. This protects the foot part arranged on the vessel floor from below against undesired exposure to heat. The foot part is advantageously designed like a vessel open at the top, which accommodates the vessel floor and at least one partial area of the circumferential wall of the preparation vessel, as well as the heat protection element arranged between the vessel floor and foot part. The heat protection element can here cover either only that partial area of the circumferential wall arranged inside of the foot part with the preparation vessel in the assembled state, or also a partial area of the circumferential wall lying above the latter, which thus lies outside of the foot part. The circumferential wall can basically be covered up to a freely selectable height by the heat protection element. This yields the thermal insulation according to the invention on the one hand, but also an acoustic insulation on the other, which is advantageous in particular in preparation vessels having an internal agitator.

It can be provided that the circumferential wall have a back cut and/or material recess so that the heat protection element abuts correspondingly in terms of shape. The correspondingly shaped abutment can here advantageously be achieved in particular by an interference fit between the heat protection element and circumferential wall of the preparation vessel. In an area adjacent to the vessel floor, the circumferential wall of the preparation vessel can here in particular have back cuts in the form of beads or the like, so that the heat protection element remains adhered thereto during an interference fit. In this embodiment, the heat protection element can be permanently arranged on the circumferential wall of the preparation vessel, and relayed to cleaning along with it or simultaneously. The heat protection element here advantageously has openings, through which the liquid that gets between the circumferential wall and heat protection element in a cleaning process can flow out again. However, the heat protection element can occasionally also be removed from the circumferential wall against the interference fit.

In addition, it is proposed that a sliding element made out of rigid plastic be arranged between the heat protection element and foot part. In particular, the rigid plastic can be a thermoplastic or thermoset. As a result of this embodiment, the foot part that is able to move relative to the vessel floor or circumferential wall of the preparation vessel can be moved along the heat protection element easily, i.e., with low resistance. Proceeding from the vessel floor or circumferential wall, the sliding element adjoins the heat protection element, so that the latter is arranged between the heat protection element and foot part with the preparation vessel in the assembled state. The sliding element supports the heat protection element, in particular when the heat protection element is made out of silicone. From a structural standpoint, the heat protection element supported by the sliding element can be arranged in the foot part, so that when removing the foot part from the vessel floor, a user simultaneously also removes the heat protection element and sliding element. It is sufficient that the sliding element only cover that partial area of the heat protection element that would otherwise abut against the foot part without the sliding element. However, it can also be provided that the sliding element as a supporting element beyond that be arranged along the circumferential wall so as to support the heat protection element. Whether or not this is required depends not least on the Shore hardness of the heat protection element.

It is proposed that the foot part be designed for the fixation of an agitator. In particular, the agitator can be a blade bearing. As described in the prior art of EP 2 875 762131, for example, the agitator runs through an opening in the vessel floor into the preparation vessel. An agitator shaft passes through the vessel floor to yield a coupling can that protrudes freely downward over the vessel floor. The agitator is fixed on the preparation vessel by the foot part, so that any relative movement relative to each other is no longer possible. With the preparation vessel in a state where inserted into an electric motor-operated food processor, the coupling cam engages into a machine-side coupler pocket, which drives the agitator. The agitator is advantageously fixed to the preparation vessel with a crimped connection between the agitator and foot part, wherein the agitator is simultaneously secured to the vessel floor.

Finally proposed aside from the preparation vessel described above is a food processor also operated by an electric motor, which has a base unit and a preparation vessel that can be connected with the base unit, in particular a preparation vessel of the aforementioned kind. The preparation vessel has a vessel floor, a heating device and a foot part that can be externally connected with the vessel floor, wherein the preparation vessel can be connected by way of the foot part with a base device, and has a heat protection element between the vessel floor and foot part, in particular between the heating device and foot part.

The features and advantages proposed above in relation to the preparation vessel also apply accordingly to the electric motor-operated food processor with such a preparation vessel.

### BRIEF DESCRIPTION OF THE DRAWINGS

The invention will be described in more detail below based on exemplary embodiments. Shown on:

FIG. 1 is an electric motor-operated food processor with a base unit and a preparation vessel inserted therein,

FIG. 2 is a floor area of the preparation vessel in a sectional view according to a first embodiment,

FIG. 3 is a floor area of the preparation vessel in a sectional view according to a second embodiment.

### DESCRIPTION OF THE EMBODIMENTS

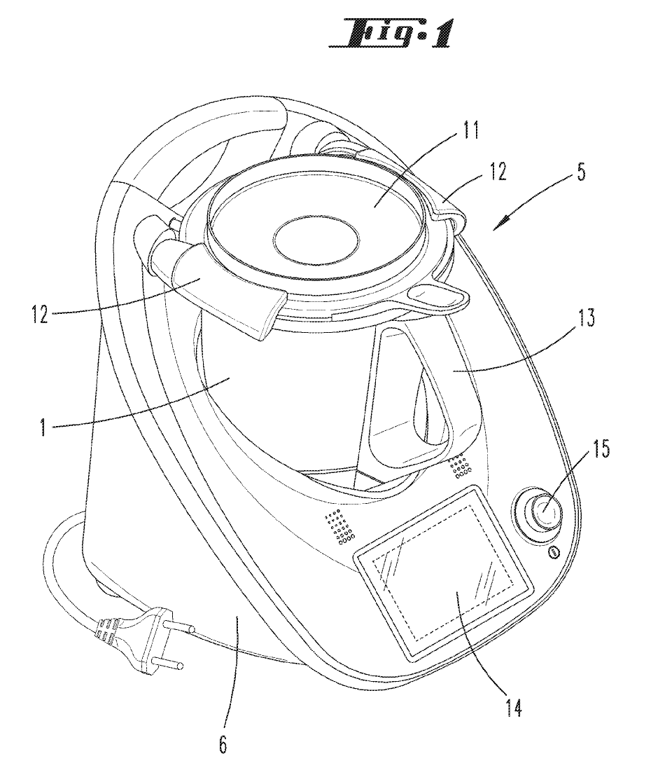

The electric motor-operated food processor 5 shown on FIG. 1 has a base unit 6, in which a preparation vessel 1 is here arranged. The base unit 6 has a display 14 for displaying possible preparation functions of the food processor 5 or the like, as well as a switch 15, which is here configured as a rotary key switch. The switch 15 can be used to turn the food processor 5 on and off on the one hand, and select preparation functions and the like on the other. Also arranged on the base unit 6 are two locking cylinders 12, which serve to lock the preparation vessel 1 with a cover 11. The preparation vessel 1 shown here further has a handgrip 13 which allows a user of the food processor 5 to grip the preparation vessel 1.

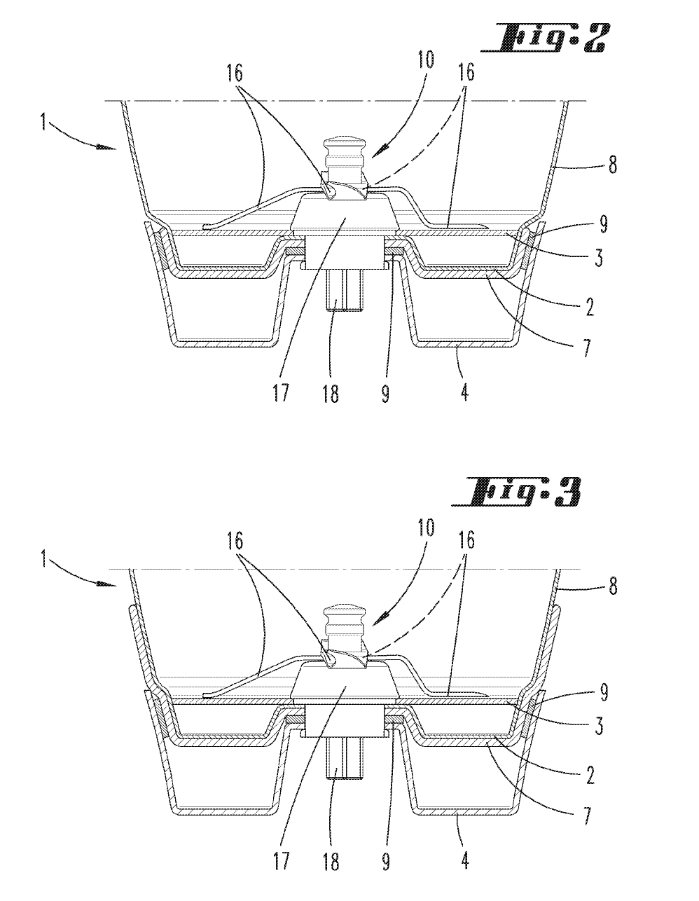

FIGS. 2 and 3 show a lower partial area of the preparation vessel 1 according to two different exemplary embodiments.

In the first embodiment shown on FIG. 2, the preparation vessel 1 has a vessel floor 2, which has a central opening for accommodating an agitator 10, which extends through the opening into the interior of the preparation vessel 1. The agitator 10 here has a blade bearing 17 with a plurality of blades 16, and a shaft 18 that can rotate relative to the blade bearing 17 and is non-rotationally joined with the blades 16. The shaft 18 can be rotated by means of a drive (not depicted) of the electric motor-operated food processor 5. In particular, an electric motor is suitable for driving purposes. Apart from the vessel floor 2, the preparation vessel 1 has a circumferential wall 8.

The vessel floor 2 has a pot-like design with a circular cross section, and carries the agitator 10 centrally on the interior. In the area of the vessel floor 2, the preparation vessel 1 further has a heating device 3, which is designed as an electrical resistance heater. In order to electrically contact the latter, contact elements (not shown in any greater detail) protruding vertically downward beyond the vessel floor are provided. With the preparation vessel 1 inserted into the base unit 6, these supply power to the heating device 3, and further preferably also control the latter.

In the exemplary embodiment shown, the agitator 10 can be secured to the preparation vessel 1. To this end, for example, the blade bearing 17 has radially outwardly extending latching projections (not depicted), which can engage into corresponding cavities in the vessel floor 2. These latching projections further grip over the plane of the vessel floor 2, so as to interact with a counter-latching means designed as a foot part 4.

The foot part 4 serving as a counter-latching means is a pot-like receiving part made out of a rigid plastic material, which likewise has an opening for the agitator 10 to pass through. The foot part 4 has counter-latching means for fixing the agitator 10, so that the agitator 10 can be secured to the vessel floor 2 by rotating the foot part 4 relative to the latter.

In the area of the heating device 3, a heat protection element 7 is arranged between the vessel floor 2 or a portion of the circumferential wall 8 and the foot part 4. The heat protection element 7 is here a flexible silicone element, which owing to its flexibility adheres to the circumferential wall 8 or vessel floor 2 in a kind of interference fit. The heat protection element 7 can be detached from the preparation vessel 1, and can thus be detached from the vessel floor 2 after removing the foot part 4. The heat protection element 7 is fluorinated so as to achieve a better sliding capacity relative to the material of the vessel floor 2 and circumferential wall 8, here metal.

Further arranged in the transitional area between the vessel floor 2 or circumferential wall 8 and the foot part 4 is a sliding element 9, which is here annularly arranged between the heat protection element 7 and foot part 4 adjacent to the agitator 10 on the one hand, and in the area of the outwardly protruding circumferential wall 8 of the preparation vessel 1 on the other. As a consequence, the sliding element 9 here consists of two parts, in the form of two annular elements. For example, the sliding element 9 is here a thermoplastic, such as polyethylene or polycarbonate, which ensures an optimal sliding capacity of the foot part 4 relative to the heat protection element 7. The sliding element 9 and heat protection element 7 do not protrude beyond the foot part 4. The foot part 4 is thus essentially only insulated in relation to the vessel floor 2 heated by means of the heating device 3 at locations that are predominantly exposed to the heat and could otherwise potentially melt, i.e., without the heat protection element 7.

For example, the heat protection element 7 here has a temperature resistance of 200° C., and forms a barrier for the thermal energy emanating from the heating device 3 or the vessel floor 2 and the circumferential wall 8. At a temperature of the heating device 3 of 160°, for example, the heat protection element 7 shields the foot part 4 in such a way that only a temperature that causes no significant change in material and/or shape in the foot part 4 is transmitted. For example, this temperature can lie in a temperature range of 100° C.

FIG. 3 shows an embodiment that deviates from that on FIG. 2, in which the heat protection element 7 protrudes over the foot part 4, and covers additional partial areas of the preparation vessel 1 along the circumferential wall 8 of the preparation vessel 1. In this embodiment, the heat protection element 7 serves not only as a thermal barrier, but also as an acoustic insulation, e.g., for noises caused by the agitator 10. Here as well, the heat protection element 7 is stretched over the circumferential wall 8 due to its flexibility, so that it abuts against the circumferential wall 8 in a kind of interference fit. In addition, back cuts and/or recesses (not depicted) can be provided on the circumferential wall 8, into which partial areas of the heat protection element 7 can be pressed. This enables an optimal hold of the heat protection element 7 on the preparation vessel 1.

In the two aforementioned embodiments, it is possible for a user of the food processor 5 to remove the heat protection element 7 and also the sliding element 9 from the preparation vessel 1. Alternatively, however, the heat protection element 7 and/or the sliding element 9 together with the preparation vessel 1 can be relayed to cleaning, e.g., in a dishwasher. It is here recommended in particular that the heat protection element 7 and potentially also the sliding element 9 have openings, through which any liquid that might have penetrated between the vessel floor 2 or circumferential wall 8 and the heat protection element 7 or sliding element 9 can be removed.

Depending on the configuration, in particular shape and dimensions, of the sliding element 9, the latter can also be designed as a support element for the heat protection element 7. This makes sense in particular in cases where the heat protection element 7 has a low Shore hardness. This makes it easier to assemble or disassemble the heat protection element 7 to or from the preparation vessel 1.

### REFERENCE LIST

1 Preparation vessel
2 Vessel floor
3 Heating device
4 Foot part
5 Food processor
6 Base unit
7 Heat protection element
8 Circumferential wall
9 Sliding element
10 Agitator
11 Cover
12 Locking cylinders
13 Handgrip
14 Display
15 Switch
16 Blade
17 Blade bearing
18 Shaft

1: A preparation vessel (1) with a vessel floor (2), a heating device (3) and a foot part (4) that can be externally connected with the vessel floor (2), wherein the preparation vessel (1) can be connected by way of the foot part (4) with a base unit (6) of an electric motor-operated food processor (5), wherein a heat protection element (7) with a temperature resistance of at least 160° C. is arranged between the vessel floor (2) and foot part (4), in particular between the heating device (3) and foot part (4).

2: The preparation vessel (1) according to claim 1, wherein the heat protection element (7) is a silicone layer, in particular a fluorinated silicone layer.

3: The preparation vessel (1) according to claim 1, wherein the heat protection element (7) is detachably arranged on the preparation vessel (1) and/or the foot part (4).

4: The preparation vessel (1) according to claim 1, wherein the heating device (3) is arranged in the vessel floor (2) of the preparation vessel (1).

5: The preparation vessel (1) according to claim 1, wherein the heat protection element (7) covers at least a partial area of the vessel floor (2), in particular at least one partial area that would be in direct mechanical contact with the foot part (4) in the absence of the heat protection element (7).

6: The preparation vessel (1) according to claim 1, wherein the heat protection element (7) covers at least a partial area of a circumferential wall (8) of the preparation vessel (1).

7: The preparation vessel (1) according to claim 1, wherein the circumferential wall (8) has a back cut and/or a material recess so that the heat protection element (7) abuts correspondingly in terms of shape, as a kind of interference fit.

8: The preparation vessel (1) according to claim 1, wherein a sliding element (9) made out of a rigid plastic, in particular a thermoplastic or thermoset, is arranged between the heat protection element (7) and foot part (4).

9: The preparation vessel (1) according to claim 1, wherein the foot part (4) is designed for fixing an agitator (10), in particular a blade bearing (17), to the preparation vessel (1).

10: An electric motor-driven food processor (5) with a base unit (6) and a preparation vessel (1) that can be connected with the base unit (6), in particular a preparation vessel (1) according to claim 1, wherein the preparation vessel (1) has a vessel floor (2), a heating device (3) and a foot part (4) that can be externally connected with the vessel floor (2), wherein the preparation vessel (1) can be connected by way of the foot part (4) with a base device (6), wherein the preparation vessel (1) has a heat protection element (7) between the vessel floor (2) and foot part (4), in particular between the heating device (3) and foot part (4).
